(19) United States
(12) Patent Application Publication
(10) Pub. No.: US 2022/0399562 A1
(43) Pub. Date: Dec. 15, 2022

(54) FASTENERLESS FUEL CELL STACK ENCLOSURE

(71) Applicant: HYDROGENICS CORPORATION, Mississauga (CA)

(72) Inventors: Andrew Hill, Scarborough (CA); Michail Gorelik, Toronto (CA); David Pubrat, Burlington (CA)

(21) Appl. No.: 17/833,482

(22) Filed: Jun. 6, 2022

Related U.S. Application Data
(60) Provisional application No. 63/210,701, filed on Jun. 15, 2021.

(51) Int. Cl. H01M 8/2475; H01M 8/2404

(52) U.S. Cl. CPC H01M 8/2475; H01M 8/2404

(57) ABSTRACT

The present disclosure generally relates to a fuel cell stack enclosure adapted to enclose a fuel cell stack The fuel cell stack enclosure includes an upper cover, a lower cover, and one or more clamping means. The upper cover encloses an upper section of the fuel cell stack and the lower cover encloses a lower section of the fuel cell stack.

### CROSS-REFERENCE TO RELATED APPLICATIONS

This nonprovisional application claims the benefit and priority, under 35 U.S.C. § 119(e) and any other applicable laws or statutes, to U.S. Provisional Patent Application Ser. No. 63/210,701 filed on Jun. 15, 2021, the entire disclosure of which is hereby expressly incorporated herein by reference.

### TECHNICAL FIELD

The present disclosure generally relates to systems and methods for enclosing a fuel cell and/or fuel cell stack in an enclosure to protect the fuel cell and/or fuel cell stack from elements of the weather.

### BACKGROUND

A typical fuel cell is comprised of many components and assemblies that may be compressed and bound with a plurality of other fuel cells into a single stack. A single fuel cell, one of the many repeating units in the fuel cell stack, is also a multi-component assembly.

A fuel cell may produce power as a voltage output. Often, a fuel cell stack is used to multiply the voltage output of a single fuel cell by the number of fuel cells stacked together. For example, a proton exchange membrane (PEM) fuel cell stack may have any number of fuel cells, such as from about 40 to about 400 fuel cells in a stack.

A typical PEM fuel cell may include a membrane electrode assembly (MEA) at the center, a gas diffusion layer (GDL) on either side of the MEA, and a bipolar plate (BPP) on either side of the GDL. The MEA is the component that ultimately enables the electrochemical reaction that generates electricity and/or power. However, the PEM fuel cell needs to be assembled with the aforementioned components to operate in a useful and reliable manner.

Fuel cells or fuel cell stacks often use hydrogen or hydrogen-rich fuel to generate electricity that may power an application, such as an electric motor. The fuel cell or fuel cell stack may generate electricity from electrochemical reactions between hydrogen (fuel) and oxygen (oxidant) in the fuel cell or fuel cell stacks. A fuel cell enclosure can provide a housing for accommodating a fuel cell or a fuel cell stack such that the fuel cell or the fuel cell stack are protected from damage or deterioration that may occur over time.

For example, fuel cell and/or fuel cell stacks may function under different environmental and weather conditions. Typically, fuel cells need to be protected from weather elements such as rain, snow, dust, moisture etc. to perform effectively and last for an extended period of time. Fuel cell and/or fuel cell stacks may be protected and/or covered in enclosures.

Existing enclosures are often large and require placing the fuel cell inside of those large structures. A cover or part of the enclosure is then installed and secured with one or more fasteners. However this type of enclosure requires that the enclosure be designed based on the size of the fuel cell or fuel cell stack being stored within it.

However, a typical fuel cell stack may have many fuel cell plates and membranes. A fuel cell stack is often compressed at a hydraulic press point such that all fuel cell plates seal against each other without any leaks. Due to individual manufacturing tolerances on the many plates in the fuel cell stack, the overall length and/or height of the finished fuel cell stack may vary considerably. This unpredictable length of any fuel cell stack makes fitting any fuel cell stack within a pre-fabricated weatherproof enclosure challenging.

Described herein are systems and methods to enclose a fuel cell and/or fuel cell stack in an enclosure that protects the fuel cell and/or fuel cell stack from the weather elements. Described herein are systems and methods to enclose a fuel cell and/or fuel cell stack in an enclosure that does not need to be manufactured to precisely fit the length or height of the fuel cell and/or fuel cell stack being protected. The present systems and methods may instead accommodate any length differences of a particular fuel cell or fuel cell stack due to part and/or manufacturing tolerances or variations.

### SUMMARY

Embodiments of the present disclosure are included to meet these and other needs. In one aspect, the present disclosure is directed to a fuel cell stack enclosure for enclosing a fuel cell stack. The fuel cell stack enclosure includes an upper cover enclosing a first section of the fuel cell stack, a lower cover enclosing a second section of the fuel cell stack, and one or more clamping means configured to couple and/or secure the upper cover to the lower cover to enclose the fuel cell stack so that the fuel cell stack is protected from contaminants outside the fuel cell stack enclosure. The upper cover includes an upper cover base and at least two upper faces extending downwardly away from the upper cover base. The lower cover includes a lower cover base and at least two lower faces extending upwardly away from the lower cover base.

The one or more clamping means may be a first clamping bar and a second clamping bar. The upper cover may include a first flanged feature and a second flanged feature, while the lower cover may include a third flanged feature and a fourth flanged feature. The first clamping bar may secure the first flanged feature and the third flanged feature, and the second clamping bar may secure the second flanged feature and the fourth flanged feature. At least one cap may be attached to an end of the first clamping bar or the second clamping bar.

A first flange seal may be positioned between the first and the third flanged feature and a second flange seal may be positioned between the second and the fourth flanged feature.

The present disclosure is also directed to a method of enclosing a fuel cell stack. The method includes positioning an upper cover over a first section of the fuel cell stack, positioning a lower cover over a second section of the fuel cell stack, and sliding at least one clamping bar over a portion of the upper cover and a portion of the lower cover to couple and/or secure the upper cover and the lower cover together. The upper cover includes an upper cover base and at least two upper faces extending downwardly away from the upper cover base. The lower cover includes a lower cover base and at least two lower faces extending downwardly away from the lower cover base.

### BRIEF DESCRIPTION OF THE DRAWINGS

FIG. 1 is a schematic showing two endplates of an enclosure attached to a fuel cell stack.

FIG. 2 is a schematic of an exploded view of an embodiment of a fuel cell stack enclosure.

FIG. 3 is a schematic showing a clamping bar attaching an upper cover and a lower cover of a fuel cell stack enclosure without any fasteners.

FIG. 4 is a schematic showing a seal between the flanged features on an upper cover and a lower cover of a fuel cell stack enclosure

FIG. 5 is a schematic showing a closed fuel cell stack enclosure.

These and other features, aspects, and advantages of the present invention will become better understood when the following detailed description is read with reference to the accompanying drawings described herein. Reference is also made to the accompanying drawings that form a part hereof and in which is shown by way of illustration specific embodiments in which the invention may be practiced. These embodiments are described in sufficient detail to enable those skilled in the art to practice what is claimed and it is to be understood that other embodiments may be utilized and that logical, mechanical, and electrical changes may be made without departing from the spirit and scope of the claims. The following detailed description is, therefore, not to be taken in a limiting sense.

### DETAILED DESCRIPTION

The present disclosure is directed to systems and methods to enclose a fuel cell 103 and/or fuel cell stack 102 in an enclosure 100 that protects the fuel cell 103 and/or fuel cell stack 102 from the weather elements. The present disclosure is further directed to an enclosure 100 that does not need to be produced precisely sized to the fuel cell 103 and/or fuel cell stack 102 being protected. The present disclosure is related to an enclosure 100 that does not require fasteners to protect the fuel cell 103 and/or fuel cell stack 102.

The fuel cell enclosure 100 or fuel cell stack enclosure 100 includes a top cover 210, a bottom cover 230, and clamping bars 310, 320. The top cover 210 is configured to enclose a first section of the fuel cell 103 and/or fuel cell stack 102 and the bottom cover 230 is configured to enclose a second section of the fuel cell 103 and/or fuel cell stack 102. The clamping bars 310, 320 are configured to secure the top cover 210 and bottom cover 230 to form the fuel cell enclosure 100 so that the fuel cell 103 and/or fuel cell stack 102 is protected from the weather elements or other contaminants without the use of fasteners.

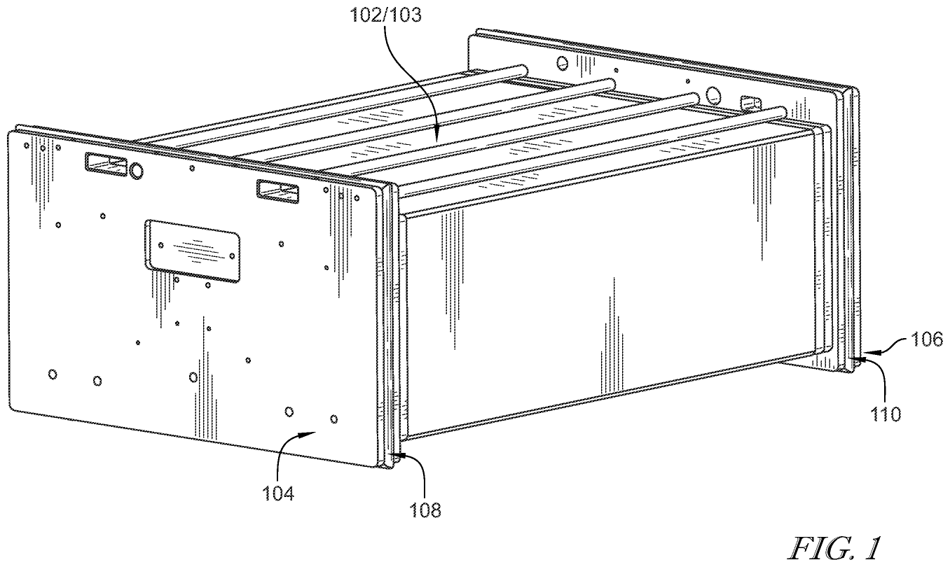

FIG. 1 shows an embodiment of a fuel cell 103 and/or fuel cell stack 102. This embodiment of the fuel cell 103 and/or fuel cell stack 102 includes two end plates 104 and 106. The end plates 104 and 106 may be connected to the fuel cell 103 and/or fuel cell stack 102 by any means, including bolts, screws, epoxy, adhesive, etc. In some embodiments, the end plates 104 and 106 may be comprised by the fuel cell enclosure 100 rather than the fuel cell 103 and/or the fuel cell stack 102.

The fuel cell 103 and/or fuel cell stack 102 also includes at least one seal 108, 110. Each seal 108, 110 is configured to prevent infiltration of water, moisture, dust, or other contaminants into the fuel cell enclosure 100 and protect the fuel cell 103 and/or fuel cell stack 102 from such contaminants. As shown in FIG. 1, the seals 108 and 110 surround the perimeter of one or both end plates 104 and 106. The seals 108 and 110 may prevent infiltration of water, moisture, dust or other contaminants into the fuel cell enclosure 100, such that the fuel cell enclosure 100 is airtight, waterproof, moistureproof, dustproof, etc., and protects the fuel cell 103 and/or the fuel cell stack 102 from contaminants. Each seal 108 and 110 may be made of plastic, rubber, or any other material that can effectively prevent infiltration of water, moisture, dust or other contaminants into the fuel cell enclosure 100. In some embodiments, the fuel cell 103 and/or fuel cell stack 102 may not include seals 108, 110.

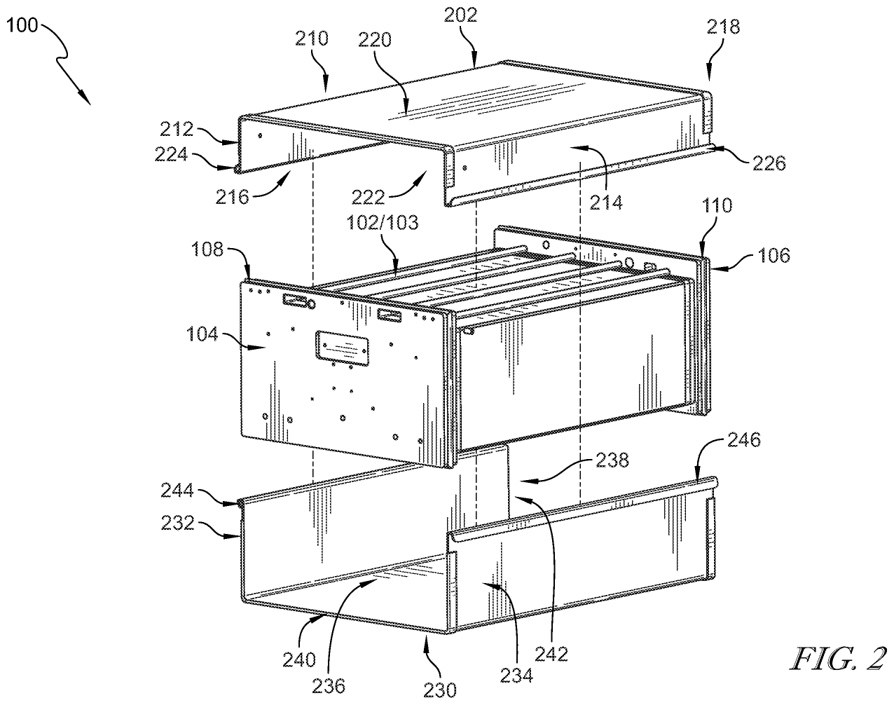

The fuel cell enclosure 100 includes an upper cover 210 and a lower cover 230, as shown in FIG. 2. The upper cover 210 and the lower cover 230 may be sized to accommodate the fuel cell 103 and/or fuel cell stack 102, irrespective of the length of the fuel cell 103 and/or fuel cell stack 102, such as any length variations in a particular fuel cell 103 and/or fuel cell stack 102 design due to part and manufacturing tolerances. The length of the fuel cell 103 and/or fuel cell stack 102 is defined horizontally between the endplates 104 and 106. The upper cover 210 and the lower cover 230 may be any shape and/or size to encompass the fuel cell 103 and/or the fuel cell stack 102. In an embodiment, the upper cover 210 and the lower cover 230 may be in the shape of a rectangle or a square.

In an embodiment, the upper cover 210 includes at least two upper faces 212 and 214 and a base 220. The upper faces 212 and 214 are configured to be coupled with the base 220. The two upper faces 212 and 214 also extend downwardly away from the base 220. The two upper faces 212 and 214 are also positioned parallel to each other, as shown in FIG. 2. In other embodiments, the two upper faces 212 and 214 may be positioned in any configuration to adapt to the geometry of the fuel cell 103 and/or the fuel cell stack 102.

The upper cover 210 further includes open ends 216, 218 and a bottom opening 222. The sides of the upper cover 210 adjacent to the two upper faces 212 and 214 are open ends 216 and 218, as shown in FIG. 2. The open ends 216 and 218 are parallel to each other. In other embodiments, the open ends 216 and 218 may be in any configuration to adapt to the geometry of the fuel cell 103 and/or the fuel cell stack 102. The bottom opening 222 of the upper cover 210 is created by the erection and connection of the two upper faces 212 and 214 to the base 220. The bottom opening 222 is located opposite to, parallel to, and/or on the underside of the base 220.

In an embodiment, the lower cover 230 includes at least two lower faces 232 and 234 and a base 240. The two lower faces 232 and 234 are configured to be coupled to and/or raised from a base 240. The two lower faces 232 and 234 are positioned to extend upwardly away from the base 240. The two lower faces 232 and 234 are also positioned parallel to each other, as shown in FIG. 2. In other embodiments, the two lower faces 232 and 234 may be positioned in any configuration to adapt to the geometry of the fuel cell 103 and/or the fuel cell stack 102.

The lower cover 230 further includes open ends 236, 238 and top opening 242. The sides of the lower cover 230 adjacent to the two lower faces 232 and 234 are open ends 236 and 238, as shown in FIG. 2. The open ends 236 and 238 are parallel to each other. In other embodiments, the open ends 236 and 238 may be in any configuration to adapt to the geometry of the fuel cell 103 and/or the fuel cell stack 102. A top opening 242 of the lower cover 230 is created by the erection and connection of the two lower faces 232 and 234 to the base 240. The top opening 242 is located opposite to, parallel to, and/or on the topside of the base 240.

In an embodiment, the open end 236 of the lower cover 230 and the open end 216 of the upper cover 210 is sized according to the end plate 104. In an embodiment, the open end 236 of the lower cover 230 and the open end 216 of the upper cover 210 may form a waterproof, dustproof and/or moistureproof fitting around the end plate 104. In some embodiments, the open end 236 of the lower cover 230 and the open end 216 of the upper cover 210 may cooperate with and/or compress the seal 108 to form a waterproof, dustproof and/or moistureproof fitting around the end plate 104 of the fuel cell 103 and/or the fuel cell stack 102. In other embodiments, the open end 236 of the lower cover 230 and the open end 216 of the upper cover 210 may attach to each other and/or enclose the end plate 104 without the use of any fasteners, bolts, screws, adhesives, or other types of fasteners known in the art.

In an embodiment, the open end 238 of the lower cover 230 and the open end 218 of the upper cover 210 is sized according to the end plate 106. In an embodiment, the open end 238 of the lower cover 230 and the open end 218 of the upper cover 210 may form a waterproof, dustproof and/or moistureproof fitting around the end plate 106. In some embodiments, the open end 238 of the lower cover 230 and the open end 218 of the upper cover 210 may cooperate with and/or compress the seal 110 to form a waterproof, dustproof and/or moistureproof fitting around the end plate 106 of the fuel cell 103 and/or the fuel cell stack 102. In other embodiments, the open end 238 of the lower cover 230 and the open end 218 of the upper cover 210 may attach to each other and/or enclose the end plate 106 without the use of any fasteners, bolts, screws, adhesives, or other types of fasteners known in the art.

In an exemplary embodiment, the upper cover 210 and the lower cover 230 may be affixed or attached to each other without the use of any bolts, screws, adhesives, or other types of fasteners to form the fuel cell enclosure 100. In an embodiment, the covers 210 and 230 may be affixed or attached to the endplates 104 and 106 without the use of any types of fasteners. Therefore, the length of the covers 210 and 230 of the fuel cell enclosure 100 are not limited by or tied to the length or height of the fuel cell 103 and/or fuel cell stack 102 with or without the endplates 104 and 106, which is advantageous for the fuel cell 103 and/or fuel cell stack 102. However, in one embodiment of the present disclosure, fasteners may be used to only attach or connect the two covers 210 and 230 together to form the fuel cell enclosure 100.

In some embodiments, the upper cover 210 and the lower cover 230 may be made of any type of material that is installed around the fuel cell 103 and/or fuel cell stack 102. In some embodiments, the covers 210 and 230 may be made of a heat conducive material. In one embodiment, the upper cover 210 and the lower cover 230 may comprise any type of metal that is installed around the fuel cell 103 and/or fuel cell stack 102. Referring back to FIGS. 1 and 2, in other embodiments, the upper cover 210 and the lower cover 230 may be configured of any material to compress the seals 108 and 110 on the sides of the end plates 104 and 106 during installation on or around the fuel cell 103 and/or fuel cell stack 102.

In some embodiments, the upper cover 210 and the lower cover 230 may be made be formed to comprise a clamshell cover 210, 230. One embodiment of the clamshell covers 210 and 230 of the present enclosure 100 is comprised of one or more sheets of metal that enable direct and secure sealing to the endplates 104 and 106 of fuel cell 103 and/or fuel cell stack 102. While any thickness of material may be used, in one embodiment, the thickness of the material (e.g., metal) comprising the upper clamshell cover 210 and the lower clamshell cover 230 may range from about 1 mm to about 10 mm, including any specific or range of thicknesses comprised therein. For example, in one embodiment, the thickness of the sheet of material comprising the clamshell covers 210 and 230 is about 2 mm thick.

In an embodiment, the upper cover 210 includes upper flanged features 224 and 226 at the edge of the upper faces 212 and 214 that are not attached to the base 220, as shown in FIG. 2. In some embodiments, the upper flanged features 224 and 226 may be formed along the entire length of the upper faces 212 and 214. In some embodiments, the upper flanged features 224 and 226 may be formed along a part of the length of the faces 212 and 214. In other embodiments, the upper flanged features 224 and 226 may be formed on the outer surface of the upper faces 212 and 214.

In an embodiment, the lower cover 230 may have lower flanged features 244 and 246 at the edge of the lower faces 232 and 234 that are not attached to the base 240. In some embodiments, the lower flanged features 244 and 246 may be formed along the entire length of the lower faces 232 and 234. In some embodiments, the lower flanged features 244 and 246 may be formed along a part of the length of the lower faces 232 and 234. In other embodiments, the lower flanged features 244 and 246 may formed on the outer surface of the lower faces 232 and 234.

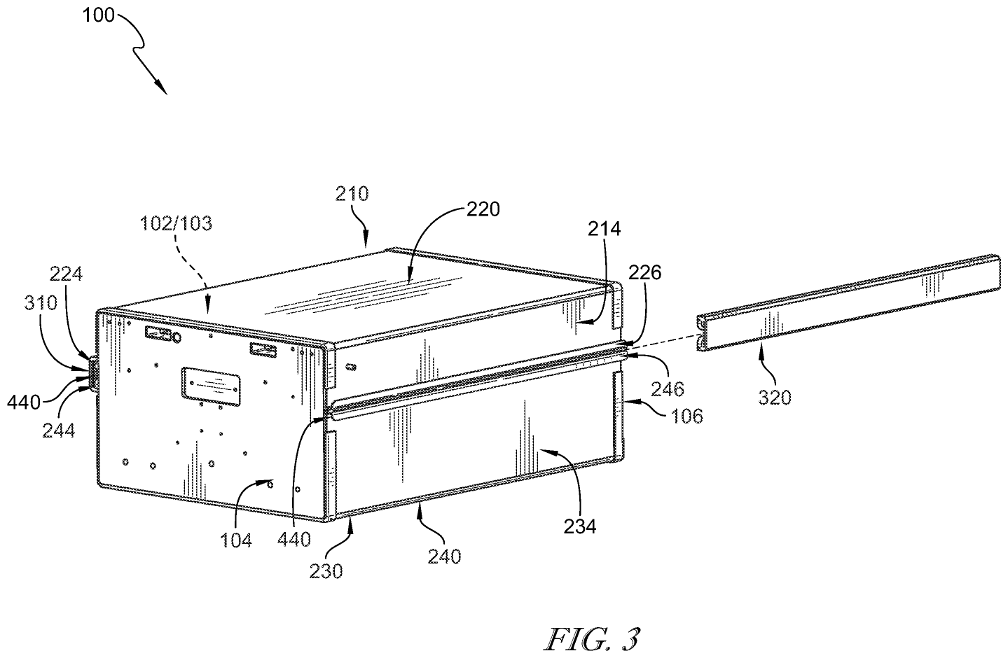

In an embodiment, the lower flanged features 244 and 246 may touch, be in contact with, be secured to and/or be in close proximity to the upper flanged features 224 and 226 when the upper cover 210 and the lower cover 230 are used to enclose the fuel cell 103 and/or fuel cell stack 102. In some embodiments, as shown in FIG. 3, one or more clamping means 310, 320 may be used to connect the upper cover 210 and the lower cover 230 adjacent to or on two opposite, parallel sides of the fuel cell 103 and/or fuel cell stack 102. In some embodiments, as shown in FIG. 3, the one or more clamping means 310, 320 may be used to connect the upper flanged features 224 and 226 and the lower flanged features 244 and 246 adjacent to or on two opposite, parallel sides of the fuel cell 103 and/or fuel cell stack 102.

In some embodiments, as shown in FIG. 3, the one or more clamping means 310, 320 may be clamping bars 310 and 320. The clamping bars 310 and 320 may be used to slide down and/or connect each side of the enclosure 100 together (e.g., the upper flanged features 224 and 226 and the lower flanged features 244 and 246 together). In another embodiment, the one or more clamping means 310, 320 may be clamping latches (not shown) that may be used to connect and/or clamp each side of enclosure 100 together (e.g., the upper flanged features 224 and 226 and the lower flanged features 244 and 246 together).

Referring to the enclosure 100 shown in FIGS. 2 and 3, a first clamping bar 310 may contact and/or connect the upper flanged feature 224 on the upper cover 210 with the lower flanged feature 244 on the lower cover 230. A separate, second clamping bar 320 may contact and/or connect the upper flanged feature 226 on the upper cover 210 with the lower flanged feature 246 on the lower cover 230. In some embodiments, the first and second clamping bars 310 and 320 may attach and/or connect the upper cover 210 to the lower cover 230. In other embodiments, the clamping bars 310 and 320 may also compress the seals 108 and 110 next to the endplates 104 and 106, such that the enclosure 100 is closed, sealed, and/or airtight to protect the fuel cell 102 and/or fuel cell stack 103 from contaminants.

In an embodiment, because there are no fastener connections between the upper cover 210, the lower cover 230, and/or the endplates 104 and 106, a single set of covers 210 and 230 may be made to enclose different fuel cell 103 and/or fuel cell stack 102 lengths and/or different fuel cell 103 and/or fuel cell stack 102 models or types. In some embodiments, the upper cover 210 and the lower cover 230 may be made to be longer than the length required by the fuel cell 103 and/or fuel cell stack 102. In other embodiments, the upper cover 210 and the lower cover 230 may be longer than the length of the fuel cell 103 and/or fuel cell stack 102 with the endplates 104 and 106, such that the upper cover 210 and the lower cover 230 may overhang the endplates 104 and 106 of the fuel cell 103 and/or fuel cell stack 102 when the length (e.g., height) of the fuel cell and/or fuel cell stack 102 being enclosed is shorter than the nominal length of the fuel cell 103 and/or fuel cell stack 102 that the enclosure 200 was manufactured to envelope or enclose. In some embodiments, the upper cover 210 and the lower cover 230 may overhang the endplates 104 and 106 of the fuel cell 103 and/or fuel cell stack 102 such that the covers 210 and 230 make contact and/or touch other components in the fuel cell 103 and/or fuel cell stack 102, and/or a fuel cell system (not shown).

The fuel cell 103 and/or fuel cell stack 102 length varies by type and manufacturer. However, the upper cover 210 and the lower cover 230 of the enclosure 100 may generally be sized from about 100% to about 110% of the size of the fuel cell 103 and/or fuel cell stack 102, including any specific or range of length comprised therein (e.g., about 105% greater). The length of the fuel cell 103 and/or fuel cell stack 102 is sometimes referred to as the height of the fuel cell 103 and/or fuel cell stack 102 when the fuel cell stack is oriented vertically on a hydraulic press during its build or manufacturing.

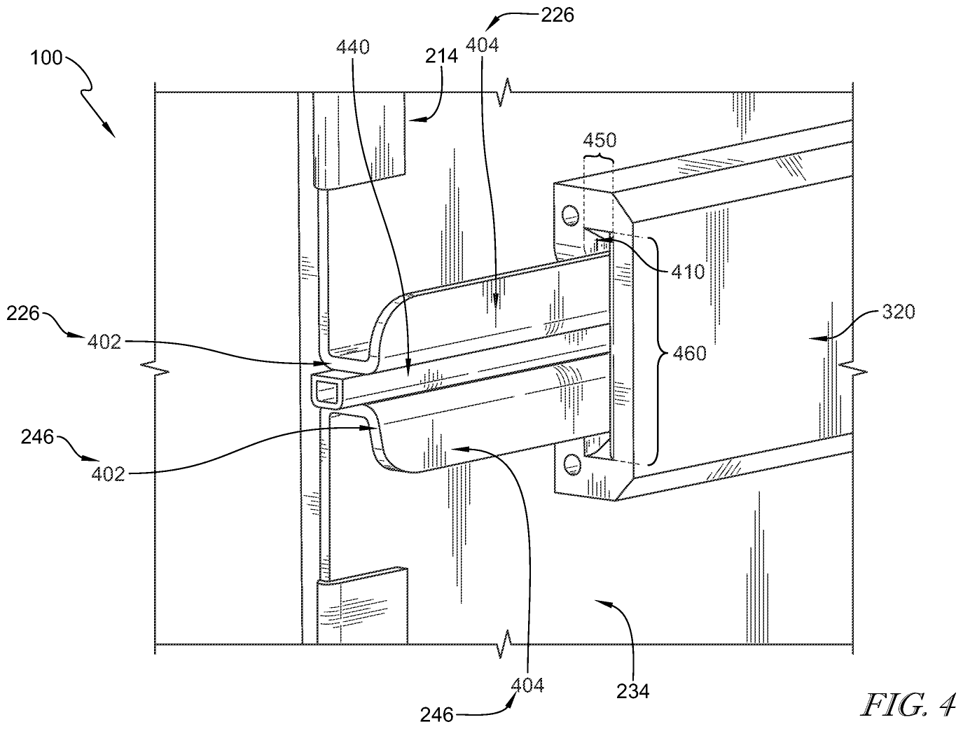

The enclosure 100 may also include on or more flange seals 440. In an embodiment of the enclosure 100, as shown in FIGS. 3 and 4, the one or more flange seals 440 may be present between the upper and lower flanged features 224 and 244 and between the upper and lower flanged features 226 and 246, respectively. The one or more flange seals 440 may be a part of the upper cover 210, the lower cover 230, the clamping bars 310, 320 and/or may be a separate component of the enclosure 100 that slides in between the upper and lower flanged features 224 and 244 and/or the upper and lower flanged features 226 and 246. The one or more flange seals 440 may be made of plastic, rubber, combinations thereof, or any other material that can effectively prevent infiltration of water, moisture, dust or other contaminants into the enclosure 100 of the fuel cell 103 and/or fuel cell stack 102. The one or more flange seals 440 may also be a solid seal or a hollow seal, such as the embodiment shown in FIG. 4.

Each of the upper and lower flanged features 224, 226, 244, and 246 may include one or more vertical faces 404 and/or one or more horizontal faces 402. In one exemplary embodiment of the enclosure 100, the upper and lower flanged features 224, 226, 244, 246 include one or more vertical faces 404. In another embodiment, the upper and lower flanged features 224, 226, 244, 246 may have one or more horizontal faces 402. In a further embodiment, the upper and lower flanged features 224, 226, 244, 246 may have one or more horizontal faces 402 and one or more vertical faces 404 that are connected or attached at an angle to each other as shown in FIG. 4.

For example, as shown in FIG. 4, the one or more horizontal faces 402 of upper flanged feature 226 may be coupled to and extend outwardly away from the upper face 214, and the one or more vertical faces 404 may be coupled to and extend upwardly away from the one or more horizontal faces 402. The one or more horizontal faces 402 may be coupled at the edge of the upper face 214 that is not attached to the base 220. The one or more vertical faces 404 may be coupled at the edge of the one or more horizontal faces 402 that is not attached to the upper face 214. The one or more horizontal faces 402 and/or the one or more vertical faces 404 of upper flanged feature 224 may have the same orientation as the one or more horizontal faces 402 and/or the one or more vertical faces of upper flanged feature 226.

Likewise, as shown in FIG. 4, the one or more horizontal faces 402 of lower flanged feature 246 may be coupled to and extend outwardly away from the lower face 234, and the one or more vertical faces 404 may be coupled to and extend downwardly away from the one or more horizontal faces 402. The one or more horizontal faces 402 may be coupled at the edge of the lower face 234 that is not attached to the base 220. The one or more vertical faces 404 may be coupled at the edge of the one or more horizontal faces 402 that is not attached to the lower face 234. The one or more horizontal faces 402 and/or the one or more vertical faces 404 of lower flanged feature 244 may have the same orientation as the one or more horizontal faces 402 and/or the one or more vertical faces of lower flanged feature 246.

The flange seal 440 may be inserted between the horizontal faces 402 of the two flanged features on the same side of the fuel cell stack enclosure 100 (e.g., between 226 and 246 and/or between 224 and 244). The clamping bars 310 and 320 may have an opening 410 designed to securely and/or tightly fit around the set of flanged features 224 and 244 and/or 226 and 246, such that the upper cover 210 and lower cover 230 are secured together around the fuel cell 103 and/or fuel cell stack 102.

The width 450 of the opening 410 of the clamping bars 310 and 320 may be sized to fit the vertical faces 404 of the flanged features 224, 226, 244, 246. The height 460 of the opening 410 of the clamping bars 310 and 320 may be sized to fit the vertical faces 404 of the flanged features 224, 226, 244, 246. In other embodiments, the flanged features 224, 226, 244, 246 and the opening 410 of each of the clamping bars 310 and 320 may be shaped differently and in any way that secures and or fastens the upper cover 210 to the lower cover 230, such that it is sealed.

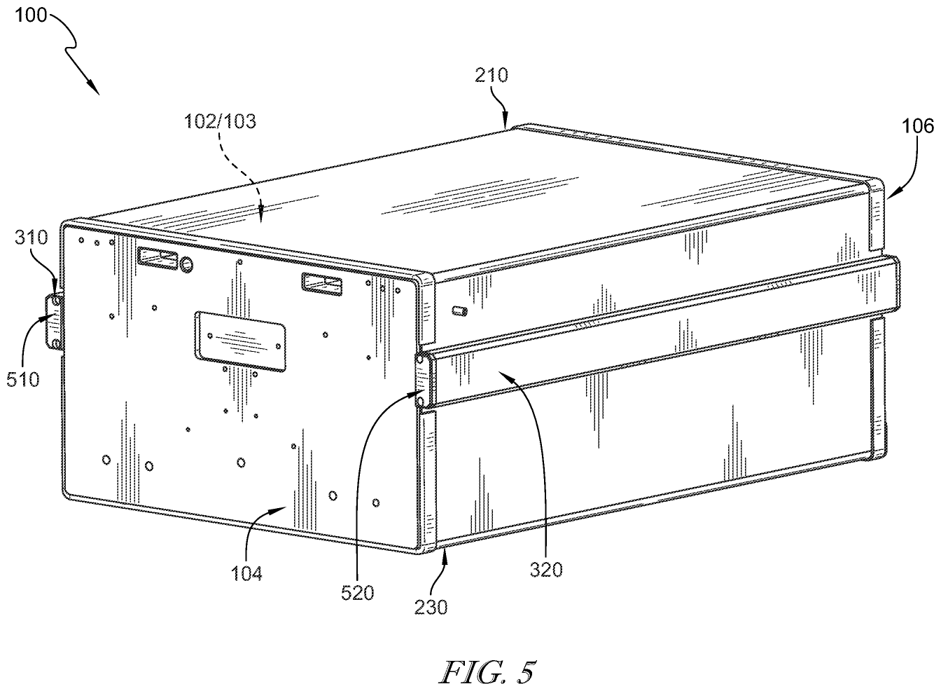

In an embodiment shown in FIG. 5, one or both ends of clamping bars 310 or 320 may be attached to a cap 510 and 520. In some embodiments, the caps 510, 520 may prevent the clamping bars 310, 320 from disengaging and/or detaching from the upper cover 210 and/or the lower cover 230 during any physical disruption, such as movement, shock, and/or vibrations experienced by the fuel cell 103 and/or fuel cell stack 102, such as during mobile applications.

In an embodiment, the fuel cell stack enclosure 100 may provide a protective weatherproof compartment for the fuel cell 103 and/or fuel cell stack 102. In some embodiments, the fuel cell stack enclosure 100 may be configured to be a volumetrically efficient and compact means of protecting the fuel cell 103 and/or fuel cell stack 102 (e.g. waterproofing or weatherproofing). This enclosure 100 may also allow the enclosed fuel cell 103 and/or fuel cell stack 102 to be integrated into tight spaces where other fuel cell products may not fit and therefore are less volumetrically compact.

In an embodiment, a method of enclosing a fuel cell 103 and/or fuel stack 102 may comprise using a fuel cell stack enclosure 100 that does not require and/or use fasteners to attach the upper cover 210 to the lower cover 230. In some embodiments, the fuel stack enclosure 100 may comprise a cover 210 and a lower cover 230 with flanged features 224, 226, 244, 246 and/or one or more clamping bars 310 and 320. The upper cover 210 and the lower cover 230 may be sized to any dimensions and not restricted to be the dimensions (e.g., length and/or height) of the fuel cell 103 and/or fuel stack 102 being enclosed. In some embodiments, a method of enclosing a fuel cell 103 and/or fuel stack 102 without fasteners that may comprise using a fuel cell stack enclosure 100 may protect the fuel cell 103 and/or fuel cell stack 102 from water, dust, and/or moisture.

Notably, in the present system and methods, the covers 210 and 230 of the fuel cell stack enclosure 100 are not manufactured to be tied or fitted to the length of the fuel cell 103 and/or fuel cell stack 102. However, in some exemplary embodiments, the covers 210 and 230 are still manufactured to fit the other fuel cell 103 and/or fuel cell stack 103 dimensions (width, depth, etc.). Moreover, in some illustrative embodiments of the present the fuel cell stack enclosure 100, the covers 210 and 230 are specifically required to fit one, more, or all of the other fuel cell 103 and/or fuel cell stack 102 dimensions (width, depth, etc.) excluding its length or height, which provides a commercially advantageous ability to produce an enclosure 100 that is designed to fit a wide array and variety of commercial fuel cells 103 and/or fuel cell stacks 102 provided by different manufacturers, while also enhancing the performance and extending the life and duration of the enclosed fuel cell 103 and/or fuel cell stack 102.

The following described aspects of the present invention are contemplated and non-limiting.

A first aspect of the present invention relates to a fuel cell stack enclosure to enclose a fuel cell stack. The fuel cell stack enclosure includes an upper cover enclosing a first section of the fuel cell stack, a lower cover enclosing a second section of the fuel cell stack, and one or more clamping means configured to couple and/or secure the upper cover to the lower cover to enclose the fuel cell stack so that the fuel cell stack is protected from contaminants outside the fuel cell stack enclosure. The upper cover includes an upper cover base and at least two upper faces extending downwardly away from the upper cover base. The lower cover includes a lower cover base and at least two lower faces extending upwardly away from the lower cover base.

A second aspect of the present invention relates to a method of enclosing a fuel cell stack. The method includes positioning an upper cover over an upper, first section of the fuel cell stack, positioning a lower cover over a lower, second section of the fuel cell stack, and sliding at least one clamping bar over a portion of the upper cover and a portion of the lower cover to couple and/or secure the upper cover and the lower cover together. The upper cover includes an upper cover base and at least two upper faces extending downwardly away from the upper cover base. The lower cover includes a lower cover base and at least two lower faces extending downwardly away from the lower cover base.

In the first and second aspect of the present invention, the fuel cell stack may include at least one end plate. The at least one end plate may have an outer perimeter and/or may include a seal surrounding the outer perimeter. The at least one end plate may be a first end plate and a second end plate, and the seal may be a first seal of the first end plate and a second seal of the second end plate. The at least one seal may be made of plastic, rubber, or any other material that can effectively prevent infiltration of water, moisture, dust, or other contaminants into the fuel cell stack enclosure.

In the first and second aspect of the present invention, the upper cover may include a first flanged feature and a second flanged feature. The first flanged feature may be attached to an edge of a first upper face of the at least two upper faces opposite an edge of the first upper face attached to the upper cover base. The second flanged feature may be attached to an edge of a second upper face of the at least two upper faces opposite an edge of the second upper face attached to the upper cover base. The first flanged feature and/or the second flanged feature may extend along at least a portion of an edge of one of the at least two upper faces of the upper cover. The first flanged feature and/or the second flanged feature may include at least one horizontal face extending away from one of the at least two upper faces and at least one vertical face extending upwardly away from the at least one horizontal face.

In the first and second aspect of the present invention, the at least two upper faces may be parallel to each other.

In the first and second aspect of the present invention, the upper cover may include open ends and a bottom opening. The open ends may be parallel to each other. The bottom opening may be created by the erection and connection of the at least two upper faces to the upper cover base.

In the first and second aspect of the present invention, the lower cover may include a third flanged feature and a fourth flanged feature. The third flanged feature may be attached to an edge of a first lower face of the at least two lower faces opposite an edge of the first lower face attached to the lower cover base. The fourth flanged feature may be attached to an edge of a second lower face of the at least two lower faces opposite an edge of the second lower face attached to the lower cover base. The third flanged feature and/or the fourth flanged feature may extend along at least a portion of an edge of one of the at least two lower faces of the lower cover. The third flanged feature and/or the fourth flanged feature may include includes at least one horizontal face extending away from one of the at least two lower faces and at least one vertical face extending downwardly away from the at least one horizontal face

In the first and second aspect of the present invention, the at least two lower faces may be parallel to each other.

In the first and second aspect of the present invention, the upper cover may include open ends and a top opening. The open ends may be parallel to each other. The top opening may be created by the erection and connection of the at least two upper faces to the upper cover base.

In the first and second aspect of the present invention, at least one of the open ends of the upper cover and at least one of the open ends of the lower cover may be sized according to one of the at least one end plate of the fuel cell stack to form a waterproof, dustproof and/or moistureproof fitting around the at least one end plate and/or may cooperate with and/or compress the seal to form the waterproof, dustproof and/or moistureproof fitting around the at least one end plate.

In the first and second aspect of the present invention, the one or more clamping means and/or the at least one clamping bar may be a first clamping bar and a second clamping bar.

In the first and second aspect of the present invention, the first and third flanged features may be coupled and/or secured together with the first clamping bar and the second and fourth flanged features may be coupled and/or secured together with the second clamping bar.

In the first and second aspect of the present invention, the first clamping bar and/or the at least one clamping bar may include an opening sized to receive at least a portion of both the first flanged feature and the third flanged feature, and/or the at least one vertical face of the first flanged feature and the at least one vertical face of the third flanged feature. The portion of both the first flanged feature and the third flanged feature may be the at least one vertical face of the first flanged feature and the at least one vertical face of the third flanged feature. The opening of the first clamping bar and/or the at least one clamping bar may have a width and/or a height sized to fit the at least one vertical face of the first flanged feature and the at least one vertical face of the third flanged feature.

In the first and second aspect of the present invention, the second clamping bar and/or the at least one clamping bar may include an opening sized to receive at least a portion of both the second flanged feature and the fourth flanged feature, and/or the at least one vertical face of the second flanged feature and the at least one vertical face of the fourth flanged feature. The portion of both the second flanged feature and the fourth flanged feature may be the at least one vertical face of the second flanged feature and the at least one vertical face of the fourth flanged feature. The opening of the second clamping bar and/or the at least one clamping bar may have a width and/or a height sized to fit the at least one vertical face of the second flanged feature and the at least one vertical face of the fourth flanged feature.

In the first and second aspect of the present invention, the fuel cell stack enclosure may further include a first and second flange seal. The first flange seal may be positioned between the first and third flanged features, and the second flange seal may be positioned between the second and fourth flanged features. The first flange seal and/or the second flange seal may be made of plastic, rubber, combinations thereof, or any other material that can effectively prevent infiltration of water, moisture, dust or other contaminants into the enclosure. The first flange seal and/or the second flange seal may be a solid seal and/or a hollow seal. The first flange seal and/or the second flange seal may be inserted between the at least one horizontal face of the first flanged feature and the at least one horizontal face of the third flanged feature and/or the at least one horizontal face of the second flanged feature and the at least one horizontal face of the third flanged feature.

In the first and second aspect of the present invention, at least one cap may be attached to an end of one of the at least one clamping bar and/or first clamping bar and/or the second clamping bar. The at least one cap may prevent the at least one clamping bar and/or the first clamping bar and/or the second clamping bar from disengaging and/or detaching from the upper cover and/or the lower cover.

In the first and second aspect of the present invention, the upper cover, the lower cover, and the one or more clamping means and/or the at least one clamping bar may cooperate to enclose the outer perimeter of the at least one end plate and/or compress the seal surrounding the outer perimeter of the at least one end plate.

In the first and second aspect of the present invention, the upper cover and the lower cover may be made of a heat conductive material and/or any type of metal that is installed around the fuel cell stack.

In the first and second aspect of the present invention, the upper cover and the lower cover may be longer than the length of the fuel cell stack and/or the fuel cell stack with the at least one end plate.

In the first aspect of the present invention, the one or more clamping means may be clamping latches that may be used to connect and/or clamp the first flanged feature and the third flanged feature together and/or the second flanged feature and the fourth flanged feature together.

In the second aspect of the present invention, the method may further include positioning at least one flange seal between the upper cover and the lower cover.

In the second aspect of the present invention, the method may further include compressing the first flanged feature, the first flange seal, and the third flanged feature together with one of the at least one clamping bar.

In the second aspect of the present invention, the method may further include compressing the second flanged feature, the second flange seal, and the fourth flanged feature together with another of the at least one clamping bar.

The features illustrated or described in connection with one exemplary embodiment or aspect may be combined with any other feature or element of any other embodiment or aspect described herein. Such modifications and variations are intended to be included within the scope of the present disclosure. Further, a person skilled in the art will recognize that terms commonly known to those skilled in the art may be used interchangeably herein.

The above embodiments and aspects are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first”, “second”, “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising”, “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists o” f refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A fuel cell stack enclosure adapted to enclose a fuel cell stack, the fuel cell stack enclosure comprising:
an upper cover enclosing a first section of the fuel cell stack, the upper cover including an upper cover base and at least two upper faces extending downwardly away from the upper cover base,
a lower cover enclosing a second section of the fuel cell stack, the lower cover including a lower cover base and at least two lower faces extending upwardly away from the lower cover base, and
one or more clamping means configured to couple the upper cover to the lower cover to enclose the fuel cell stack so that the fuel cell stack is protected from contaminants outside the fuel cell stack enclosure.

2. The fuel cell stack enclosure of claim 1, wherein the one or more clamping means are a first clamping bar and a second clamping bar.

3. The fuel cell stack enclosure of claim 2, wherein the upper cover includes a first flanged feature attached to an edge of a first upper face of the at least two upper faces opposite an edge of the first upper face attached to the upper cover base and a second flanged feature attached to an edge of a second upper face of the at least two upper faces opposite an edge of the second upper face attached to the upper cover base, and
wherein the lower cover includes a third flanged feature attached to an edge of a first lower face of the at least two lower faces opposite an edge of the first lower face attached to the lower cover base and a fourth flanged feature attached to an edge of a second lower face of the at least two lower faces opposite an edge of the second lower face attached to the lower cover base.

4. The fuel cell stack enclosure of claim 3, wherein the first and the third flanged feature are coupled together with the first clamping bar and the second and the fourth flanged feature are coupled together with the second clamping bar.

5. The fuel cell stack enclosure of claim 4, wherein the fuel cell stack enclosure further comprises a first and second flange seal, and wherein the first flange seal is positioned between the first and the third flanged feature and the second flange seal is positioned between the second and the fourth flanged feature.

6. The fuel cell stack enclosure of claim 2, wherein at least one cap is attached to an end of one of the first clamping bar and the second clamping bar.

7. The fuel cell stack enclosure of claim 1, wherein the fuel cell stack includes at least one end plate having an outer perimeter, and wherein the upper cover, the lower cover, and the one or more clamping means of the fuel cell stack enclosure cooperate to enclose the outer perimeter of the at least one end plate.

8. The fuel cell stack enclosure of claim 7, wherein the at least one end plate includes a seal surrounding the outer perimeter, and wherein the upper cover, the lower cover, and the one or more clamping means of the fuel cell stack enclosure cooperate to compress the seal surrounding the outer perimeter of the at least one end plate.

9. The fuel cell stack enclosure of claim 3, wherein the first clamping bar includes an opening sized to receive at least a portion of both the first flanged feature and the third flanged feature, and wherein the second clamping bar includes an opening sized to receive at least a portion of both the second flanged feature and the fourth flanged feature.

10. A method of enclosing a fuel cell stack comprising:
positioning an upper cover over an first section of the fuel cell stack, the upper cover including an upper cover base and at least two upper faces extending downwardly away from the upper cover base,
positioning a lower cover over a second section of the fuel cell stack, the lower cover including a lower cover base and at least two lower faces extending downwardly away from the lower cover base, and
sliding at least one clamping bar over a portion of the upper cover and a portion of the lower cover to couple the upper cover and the lower cover together.

11. The method of claim 10, wherein the upper cover comprises a first and a second flanged feature and the lower cover comprises a third and a fourth flanged feature.

12. The method of claim 11, further comprising securing the first and the third flanged features together with a first clamping bar of the at least one clamping bar and securing the second and the fourth flanged features together with a second clamping bar of the at least one clamping bar.

13. The method of claim 11, further comprising positioning a first flange seal between the first and the third flanged feature and a second flange seal between the second and the fourth flanged feature.

14. The method of claim 10, further comprising positioning at least one flange seal between the upper cover and the lower cover.

15. The method of claim 11, wherein the first flanged feature extends along at least a portion of an edge of one of the at least two upper faces of the upper cover and the second flanged feature extends along at least a portion of an edge of another of the at least two upper faces of the upper cover.

16. The method of claim 15, the third flanged feature extends along at least a portion of an edge of one of the at least two lower faces of the lower cover and the fourth flanged feature extends along at least a portion of an edge of another of the at least two lower faces of the lower cover.

17. The method of claim 13, further comprising compressing the first flanged feature, the first flange seal, and the third flanged feature together with one of the at least one clamping bar.

18. The method of claim 17, further comprising compressing the second flanged feature, the second flange seal, and the fourth flanged feature together with another of the at least one clamping bar.

19. The method of claim 12, wherein the first flanged feature includes at least one horizontal face extending away from one of the at least two upper faces and at least one vertical face extending upwardly away from the at least one horizontal face, wherein the third flanged feature includes at least one horizontal face extending away from one of the at least two lower faces and at least one vertical face extending downwardly away from the at least one horizontal face, and wherein the first clamping bar includes an opening sized to receive the at least one vertical face of the first flanged feature and the at least one vertical face of the third flanged feature.

20. The method of claim 19, wherein the second flanged feature includes at least one horizontal face extending away from another of the at least two upper faces and at least one vertical face extending upwardly away from the at least one horizontal face, wherein the fourth flanged feature includes at least one horizontal face extending away from another of the at least two lower faces and at least one vertical face extending downwardly away from the at least one horizontal face, and wherein the second clamping bar includes an opening sized to receive the at least one vertical face of the second flanged feature and the at least one vertical face of the fourth flanged feature.
